(19) United States
(12) Patent Application Publication
(10) Pub. No.: US 2005/0207635 A1
(43) Pub. Date: Sep. 22, 2005

(54) Method and apparatus for printing documents that include MICR characters

(75) Inventors: Aaron P. Lazar, Geneseo, NY (US); Jeffrey S. Baker, Hamlin, NY (US)

Correspondence Address: Mark G. Bocchetti;Patent Legal Staff, Eastman Kodak Company, 343 State Street, Rochester, NY, 14650-2201, US

(73) Assignee: Eastman Kodak Company

(21) Appl. No.: 11/038,616

(22) Filed: Jan. 19, 2005

Related U.S. Application Data
(60) Provisional application No. 60/554,145, filed on Mar. 18, 2004.

(51) Int. Cl. G06K 9/00

(52) U.S. Cl. 382/139

(57) ABSTRACT

A computerized method of creating and printing documents having one or more magnetic ink characters includes identifying and positioning data fields within a displayed representation of the document to be printed. Locations are identified within the data fields and elsewhere on the displayed representation of the document where magnetic ink characters are to be printed. The identified locations where magnetic ink characters are to be printed are compared with predetermined specifications for such locations. The identified locations on the representation of the document to be printed are adjusted to conform to the predetermined specifications.

### CROSS-REFERENCE TO RELATED APPLICATIONS

This application claims the benefit of U.S. Provisional Patent Application No. 60/554,145, filed Mar. 18, 2004.

### FIELD OF THE INVENTION

The present invention relates generally to printing documents that include one or more magnetic ink characters and, more particularly, to a method and apparatus for aligning and printing such characters within a document.

### BACKGROUND OF THE INVENTION

Billions of personal checks, business checks and other commercial documents are processed each year through the banking system of the United States. Similar volumes of documents are processed by the banking systems of other countries. The volume of checks being processed continues to increase despite the availability of paperless methods of making payments and/or transferring money. In order to facilitate automated and efficient computer-controlled processing of the high volume of checks and other commercial documents banks utilize magnetic ink character recognition (MICR). Each document includes a line of characters printed in magnetic ink, referred to as the MICR line. Reading or sorting machines read the MICR line by passing the document through a charging station and a reading station. The charging station charges the magnetic ink characters of the MICR line. As the document passes through the reading station the electronic pulses caused by the passing charged magnetic characters are detected or read and decoded to determine the characters to which they correspond.

In order to ensure accurate processing, the document and the MICR line itself must conform to certain requirements, such as the type of paper utilized, the dimensions of the document, the location of the MICR line, the dimensions and format of the MICR characters, etc. One such standard is Standard X9.100-20, X9.100.30 (X9.27) and X9.100-160 (X9.13), entitled Print and Test Specifications for Magnetic Ink Character Recognition. The X-9 specification sets forth the specific type fonts, the position of the MICR line, the location of fields and characters within the MICR line, and the magnetic characteristics of the printed magnetic characters. If a document does not meet the standards, it will be rejected by the check reading/sorting machine.

MICR rejects may also be caused by a printed image that is uneven, i.e., where the magnetic ink is not evenly distributed, has voids, is not spaced correctly, by type that is too thick or thin, or by dimensional problems stemming from faulty composition or plate making. Additionally, MICR rejects are often due to unwanted magnetic signals caused by extraneous ink in the area sensed by the reader/sorter. MICR rejects may also be due to the printing system that is used to transfer the image to paper. For example, an impact printing system, such as letterpress, may create a depressed impression in the paper, referred to as a debossment, at a particular character position which may make the character magnetically difficult to read.

The accuracy of the MICR check reading/sorting process has been refined to a relatively high level. The percentage of error in the process attributable to misprinted documents is typically from approximately one-half of one percent to approximately one and one-half percent. However, due to the sheer number of documents being processed, even a small percentage of error results in a large number of rejected documents which must then be processed manually. For example, a relatively large bank that processes one million documents per day with a one and one-half percent reject rate will have 15,000 rejected documents per day. Each of these 15,000 rejected documents must be handled manually and a corrected MICR code must be placed on the document so that it may be reread.

The producer or printer of a document or check that does not conform to the pertinent specifications may be held liable for the increased processing costs that arise from the need to manually process the nonconforming document. Therefore, in order to avoid such costs, document producers carefully monitor the printed documents they are producing to ensure they conform to the required standards. Conventionally, printers or document producers ensure that the documents they produce conform to the required standards by carefully setting-up or laying out the documents, especially the characteristics of the MICR line. For example, the lay out of the document may be inverted, i.e., the document may be printed upside down, in order to position the MICR line at the top rather than the bottom of the document and thereby reduce positional errors in the MICR line due to variations in paper length and/or errors in paper registration. One or more actual documents are then printed and examined to ensure that the location and positioning of the MICR line conform to the applicable specifications. This examination is conventionally performed by one of several relatively time-consuming and off-line processes that require the production of at least one printed document.

More particularly, one conventional method of examination is to visually compare a printed document with a MICR verification film overlay template or gauge that indicates the acceptable location of the MICR line and the positions of the individual characters thereof to determine whether the document and the MICR line conform to specifications. Another conventional method of examination processes a printed document through a document reader/scanner which reads and decodes the MICR line and thereby determines whether the document and MICR line conform to specifications. These methods, although suitable, are relatively manual in nature and time consuming in that they require one or more documents be completely laid out, printed and only then examined for conformance. If variation in the printing process is to be considered, a relatively large sample of documents must be produced and examined for conformance. To ensure ongoing conformance with specifications, process or quality checks must be periodically performed on printed documents and adjustments made. As such, the conventional methods are conducted on a sample or quality check basis rather than according to a real-time method that monitors the printing process and ensures the document being produced and the MICR lines conform to specifications.

Therefore, what is needed in the art is an improved process of determining whether a document and the MICR lines thereof conform to applicable specifications.

Furthermore, what is needed in the art is a method and apparatus for determining whether a document and the MICR lines thereof are likely to conform with applicable specifications without requiring the printing of one or more actual documents.

Moreover, what is needed in the art is a method and apparatus for adjusting a printing process in real time to ensure ongoing conformance of the document and the MICR lines thereof with applicable specifications.

### SUMMARY OF THE INVENTION

The present invention provides a computerized method of creating and printing documents having one or more magnetic ink characters, and for ensuring prior to and during printing that such documents, when printed, will conform to applicable specifications.

The invention comprises, in one form thereof a method that includes identifying and positioning data fields within a displayed representation of the document to be printed. Locations are identified within the data fields and elsewhere on the displayed representation of the document where magnetic ink characters are to be printed. The identified locations where magnetic ink characters are to be printed are compared with predetermined specifications for such locations. The identified locations on the representation of the document to be printed are adjusted to conform to the predetermined specifications.

An advantage of the present invention is that the likelihood that documents and/or MICR characters therein will conform to applicable specifications is improved without requiring the printing of actual documents.

Another advantage of the present invention is that the locations and positioning of the MICR characters is adjusted to ensure ongoing conformance of the documents and the MICR lines thereof to applicable specifications.

### BRIEF DESCRIPTION OF THE DRAWINGS

The above-mentioned and other features and advantages of this invention, and the manner of attaining them, will become apparent and be better understood by reference to the following description of one embodiment of the invention in conjunction with the accompanying drawings, wherein:

FIG. 1 shows an exemplary MICR verification film overlay or template, and illustrates the various requirements for document size, layout, and the size and location of the MICR fields and characters;

FIG. 2 is a diagrammatic view of one embodiment of a system of the present invention for aligning and printing MICR documents; and

FIG. 3 is a flow diagram of one embodiment of the method of the present invention for aligning and printing MICR documents.

Corresponding reference characters indicate corresponding parts throughout the several views. The exemplifications set out herein illustrate one preferred embodiment of the invention, in one form, and such exemplifications are not to be construed as limiting the scope of the invention in any manner.

### DETAILED DESCRIPTION OF THE DRAWINGS

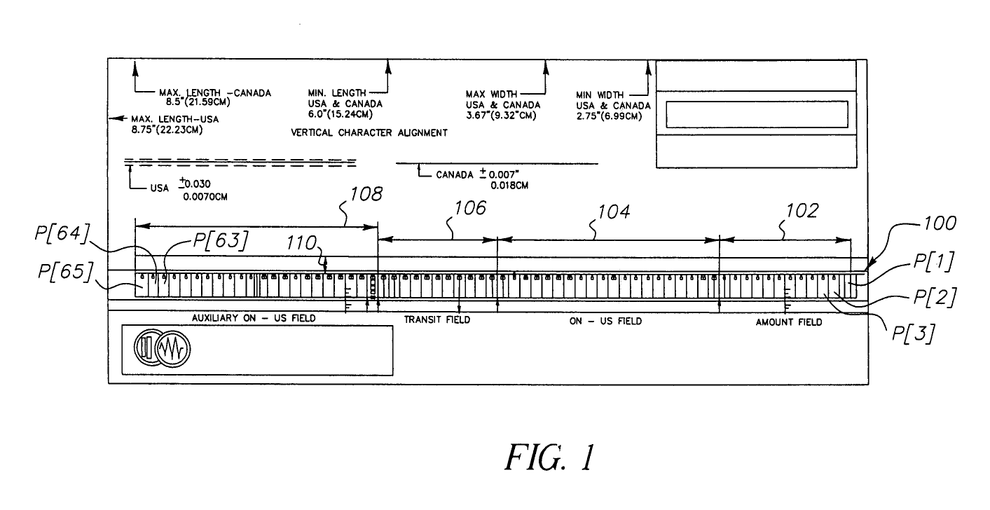

Referring now to FIG. 1, an exemplary MICR verification film overlay or template for a check is shown. The overlay illustrates the various requirements for check or document size, layout, and the size and location of the MICR fields and characters. More particularly, it is seen that the MICR line of the overlay includes a plurality of individual spaces or positions 1, 2, 3, 4, . . . 63, 64 and 65 (hereinafter indicated as P[number]). These individual MICR positions P[1] through P[65] collectively form MICR line 100. The individual positions are grouped together to separate MICR line 100 into several fields. More particularly, MICR line 100 includes amount field 102, on-us field 104, transit field 106 and auxiliary on-us (aux-on-us) field 108.

Amount field 102 is a fixed-length field that is defined by positions P[1] through P[12], and the characters therein indicate the amount for which the check is payable. On-Us field 104 is defined by positions P[13] through P[32], and the content thereof is determined by the bank upon which the check is drawn. Generally, on-us field 104 contains an account number. Transit field 106 is defined by positions P[33] through P[43], and is also a fixed-length field. Transit field 106 contains characters that indicate the financial institution upon which the check is drawn. Aux-On-Us field 108 is defined by positions P[45] through P[65] and the content thereof generally contains numbering, transaction codes, and other internal bank codes. Aux-On-Us field may optionally begin at position P[46] or higher. As is also shown in FIG. 1, the maximum tolerance for all fields is ±0.0625 inches from right to left, character spacing tolerance is ±0.01 inches, and the MICR clear band 110 which must be free of all printing with the exception of the MICR characters themselves. The above-described and other specifications shown in FIG. 1 are well known to those of skill in the art of MICR document processing and/or printing.

One of the conventional processes of verifying that the MICR line of a document conforms to the requirements consists of placing the document under a MICR verification film overlay such as the one depicted in FIG. 1, aligning the overlay and document, and visually examining the location of the MICR line and the positions of the characters therein relative to the positions indicated by the overlay. Such a process occurs, naturally, after the processes of laying out and printing the document have been completed. Thus, if the document and/or MICR line does not conform to the pertinent specifications the layout of the document must be adjusted, one or more new test documents must be printed, and the sample documents must be examined for conformance. The process of adjustment, printing and examining is iterated until the resulting document meets the required specifications and is otherwise satisfactory. A similarly iterative process is also performed when a check scanner/reading device is used to examine or verify the document and the MICR line thereof.

In contrast, the apparatus and method of the present invention enable the layout of a document to be created, compared to the required specifications, adjusted, compared again as necessary to the specifications, adjusted again as necessary, and finally printed. Thus, the present invention eliminates the need to print one or more sample documents in order to verify conformance of the document with the MICR specifications. Further, the method and apparatus of the present invention enable real-time adjustment of the document layout to thereby adjust for process variations, including variation in paper size and registration.

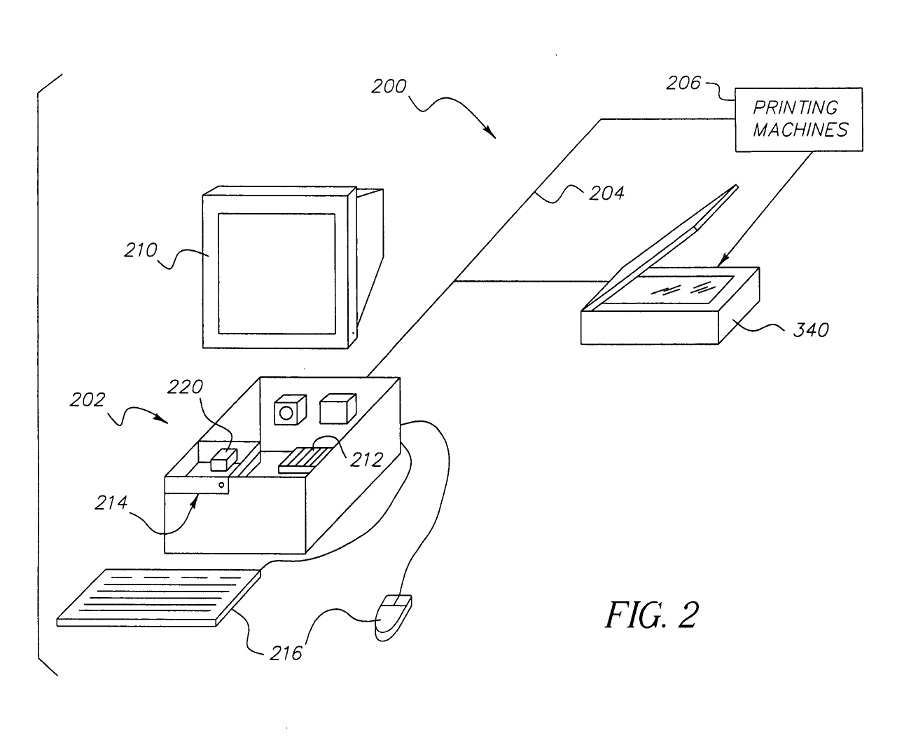

Referring now to FIG. 2, a diagrammatic view of one embodiment of a system of the present invention for aligning and printing MICR documents is shown. System 200 includes a layout terminal or computer 202 that is interconnected via network 204 with one or more printing machines 206.

Computer 202 is a conventional personal computer having a display 210, memory 212, one or more storage devices 214, and one or more input devices 216. Computer 202 executes application software 220 which, as will be more particularly described hereinafter, enables a user to design and layout a document that includes MICR characters, display or preview a printed version of the document, select a template that indicates the proper location of the MICR line and the positioning of the MICR characters within the document, compare the locations and positions of the MICR line and characters against the selected template, adjust the location and position of the MICR line and characters, and print the finished document.

More particularly, memory 212 includes random access memory and read only memory. Storage device 214 is configured as, for example, one or more of a hard disk drive, removable memory card, or floppy disk drive. Input devices 216 include one or more of a keyboard, mouse, or other input device. Application software 220 is stored in one of storage devices 214, and at least a portion thereof is read into memory 212 for execution by computer 202. Network 204 is a conventional network that enables the exchange of data, such as, for example, a local area network, wide area network, an intranet or the Internet. The one or more printing machines 206 are conventional printers configured for printing with magnetic ink or toner.

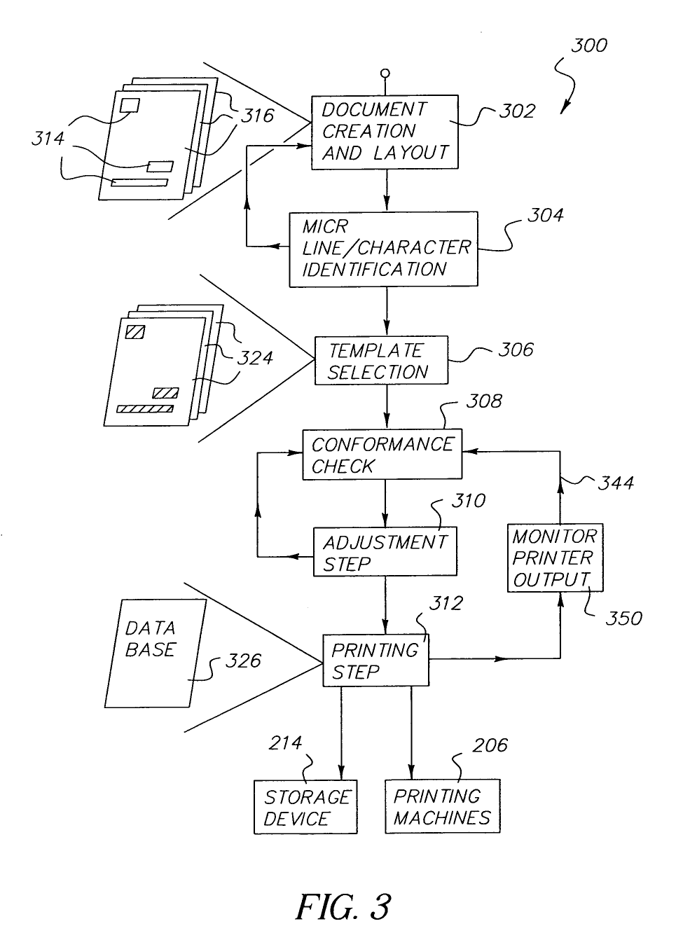

Application software 220 performs, at least in part, the method of the present invention. One embodiment of the method for aligning and printing MICR documents of the present invention is shown in FIG. 3. Method 300 includes document creation and layout process 302, MICR line/character identification process 304, template selection process 306, conformance check 308, adjustment step 310 and printing step 312. Generally, method 300, as embodied by application software 202 executed on system 200, enables a user thereof to design and layout a document that includes MICR characters, display or preview a printed version of the document, select a template that is indicative of the proper location of the MICR line and the positioning of the MICR characters therein, compare the characteristics of the MICR line and characters against the selected template, adjust the location and position of the MICR line and characters, and print the finished document.

Document creation and layout process 302 enables a user to design, layout and create a document, such as a check. Document creation and layout process 302 includes conventional processes, such as, for example, selection of paper size and orientation (landscape or portrait), establishing margins, etc. Further, document creation and layout process 302 involves the placement and identification of data fields 314 within the document. Document creation and layout process 302 optionally provides for the selection of one of a plurality of standard document templates 316, such as, for example, a standard check template or rebate template each of which have predetermined paper sizes, predetermined margins and predetermined data fields 314 within which text and other characters are printed in printing step 312. The selected one of templates 316, or the document being created if a standard template 316 is not being used, is displayed on display 210 of system 200.

The user can adjust the characteristics of the displayed standard template 316 or document, such as, for example, adjust margins and layout, insert and/or delete data fields 314, etc., as needed. Further, the user selects the font and size of the printing to be used for the text and characters that will appear in each of the data fields 314. At any time during the execution of method 300 and/or document creation and layout process 302 the characteristics of the document or template being developed can be saved as a new template or blank form for later retrieval and use, as will be more particularly described hereinafter.

The data fields 314 of the document or template which will contain the same information or which have fixed content in each of the documents to be printed are then completed by the user of system 200 using one or more of input devices 216. For example, if the document being prepared is a run of checks that will be drawn upon the same bank, the name of that payor bank will and the data fields 314 corresponding to the transit field 106 of the MICR line will be constant and not change for the entire run of checks to be printed.

At any time during the document creation and layout process 302, MICR character/line and character identification process 304 is executable by a user of system 200. More particularly, in order to execute MICR character/line identification process 304 the user selects a “MICR select” option, such as, for example, from a pull-down menu of application software 220 and then selects the data fields, individual character(s) or line of characters on the displayed document that are to be printed in MICR toner or ink. For example, again assuming the document displayed and to be printed is a check, the user executes MICR character/line identification process 304 and selects the MICR line of the check to thereby identify the MICR line as a line of text to be printed in MICR ink or toner.

Template selection process 306 involves the selection of one of a plurality of MICR verification templates 324 to be superimposed over the document displayed on display 210. The templates 324 are generally similar to and/or are digital representations of MICR verification film overlays or templates, such as, for example, the MICR overlay illustrated in FIG. 1. Templates 324 are configured as, for example, computer readable files that correspond to and are displayed as bitmap images of the MICR verification film overlays or templates. In addition to including the required characteristics (i.e., location and positions) of the MICR text lines and characters, the templates 324 also indicate acceptable paper sizes, margins, clear bands, data field locations, character spacing, etc.

After the appropriate template 324 has been selected and superimposed upon the document being created, conformance check 308 is performed. Conformance check 308 can be relatively manual in nature, wherein the user of computer system 200 visually compares the characteristics of the document, including the location of the MICR line(s) and the positions of the individual MICR characters therein, to the superimposed template.

Preferably, however, conformance check 308 is a more automated procedure. More particularly, conformance check 308 is executed by a user selecting, for example, via a pull down menu of application software 220, a “conformance check” option. In response thereto, application software 220 compares the characteristics of the document being displayed, including the location of the MICR line(s) (or a bit map thereof) and the positions of the individual MICR characters therein, to the bitmap of the selected template 324. Any non-conforming document characteristics are highlighted, flagged, or otherwise indicated on display 210. If there are no non-conforming areas, a corresponding indication or message is displayed to the user.

Adjustment process 310 is executed by a user selecting, for example, via a pull down menu of application software 220, an “adjustment” option. Alternatively, adjustment process 310 is automatically invoked when a non-conformance is identified within the document by conformance check 308. Adjustment process 310 involves a user adjusting, for example, the location of the MICR on the displayed document, the position of individual characters within the MICR line, and/or the position of one or more data fields 314 on the displayed document. The user performs such adjustment using one of the several input devices 216 connected to computer 202. At any time during the adjustment process 310, a user can request a conformance check 308 be performed by system 200 by, for example, accessing the pull down menu of application software 220 and selecting the “conformance check” option.

Printing step 312 is performed after the user has completed adjustment step 310, if necessary, and executed a conformance check 308 that indicated no non-conformances were present in the displayed document. Optionally, prior to executing printing step 312 and/or at any time during the execution of method 300, a user executes a “save document” step by, for example, accessing a pull-down menu of software 220 to thereby save the document, such as for example, on storage device 214 of system 200, for later access and use. Printing step 312 is executed by a user selecting, for example, via a pull down menu of application software 220, a “print documents” option.

System 200, in response to the instruction to execute printing step 312 sends a file corresponding to the completed document to be printed to one or more of printing machines 206 or saves the document to a file which is stored, for example, on storage device 214 or some other suitable storage device for subsequent printing. Alternatively, a print merge process is performed which merges data from a computer database 326 or other data source with the data fields 314 of the displayed document, and causes a plurality of documents to be printed by printer 206 or prints a plurality of documents to a corresponding plurality of files. Printing step 312 may be a multi-step process which involves printing the non-MICR characters in one step and the MICR characters in a separate step.

By enabling adjustments to the location and/or spacing of the characteristics of the displayed document, including the MICR data fields, MICR characters and/or MICR lines as well as the non-MICR data fields, characters, and lines to be printed on the document, method 300 improves the likelihood that the characteristics of the documents that are ultimately printed will conform to the applicable requirements and specifications. Thus, the method of the present invention substantially reduces the amount of guesswork involved in the creation and laying of documents having MICR lines/characters. Further, the cycle time required to create and layout a document that conforms to the applicable requirements is also substantially reduced relative to the conventional method of printing MICR documents and then checking them for conformance.

Optionally, and as shown in FIGS. 2 and 3, capability is added to system 200 and method 300 to incorporate real-time or closed-loop control to the document printing process. Generally, by optically scanning, either on a continuous or sample basis, the output of one or more of printing machines 206, displaying the scanned document on display 210, and executing a conformance check 308 on the scanned document and, if necessary, executing adjustment process 310, the conformance of the documents being printed by system 200 is monitored and verified.

More particularly, and with reference to FIG. 2, optical scanner 340 is associated with one or more of printing machines 206. Optical scanner 340 may be integral with the printing machines 206 or be configured as a separate optical scanner that receives via automated paper handling systems, represented generally by arrow 342, and scans at least some of the documents printed by printing machines 206. Optical scanner 340 is connected via network 204 with computer 202, and is thus able to provide printed document data files 344, such as, for example, bitmap files, that are representative of the documents being printed by printing machines 206. The document data files 344 are displayable on display 210. Conformance of the printed documents that correspond to document data files 344 with the applicable requirements and/or specifications is determined according to method 300 as executed by application software 220, as described above. More particularly, a selected one of document data files 344 is displayed on display 210, and conformance check 308 and adjustment process 310 are executed.

Method 300, as best shown in FIG. 3, further includes a “monitor printer output” process 350, which is executable by a user of software 220 selecting, such as, for example, via a pull-down menu of software 220, a monitor printer output option. Selection of the monitor printer output option enables a user to select either a specific document data file 344 for display, or to select for display the data files 344 corresponding to a particular printing machine 206. Once a particular data file or files 344 are displayed, the user is able to execute conformance check 308 and adjustment step 310, which are executed according to the steps and perform the functions described above. Adjustments made during adjustment step 310 are made “on the fly” without requiring any interruptions to the ongoing printing step 312.

Thus, by incorporating real-time and/or closed loop control into the process of printing documents containing MICR lines and/or characters, method 300 substantially reduces the likelihood of printing a batch of documents containing a non-conformance. Further, the real-time and/or closed loop control provided by the monitor printer output process 350 of method 300 and the ability to adjust document characteristics on the fly reduces the likelihood of printing a substantial quantity of documents that are nonconforming due to printing process variations, such as, for example, variations in paper length, registration errors, paper handling variation, etc.

While this invention has been described as having a preferred design, the present invention can be further modified within the spirit and scope of this disclosure. This application is therefore intended to cover any variations, uses, or adaptations of the present invention using the general principles disclosed herein. Further, this application is intended to cover such departures from the present disclosure as come within the known or customary practice in the art to which this invention pertains and which fall within the limits of the appended claims.

### PARTS LIST

1-65. MICR Position Places
100. MICR line
102. Amount Field
104. ON-US Field
106. Transit Field
108. AUX ON-US Field
200. System
202. Computer
204. Network
206. Printing Machines
210. Display
212. Memory
214. Storage Device
216. Input Devices
220. Software
300. Method
302. Creation & Layout
304. MICR Identification
306. Template Selection
308. Conformance Check
310. Adjustment
312. Printing
314. Data Fields
316. Standard Templates
324. Template
340. Optical Scanner
342. Document Data files
350. Monitor Output

1. A computerized method of creating and printing documents having one or more magnetic ink characters, said method comprising:
laying out a document to be printed by identifying and positioning data fields within a displayed representation of the document to be printed;
identifying the locations within the data fields and elsewhere on the displayed representation of the document where magnetic ink characters are to be printed;
comparing the identified locations where magnetic ink characters are to be printed with predetermined specifications for such locations; and
adjusting the identified locations on the representation of the document to be printed to conform to the predetermined specifications.

2. The method of claim 1, wherein said laying out step comprises displaying on a display of a computer system the representation of the document to be printed.

3. The method of claim 2, wherein said laying out step includes:
selecting and displaying on the display one of a plurality of document templates, the document templates comprising computer readable files stored in one of a memory or a storage device of the computer system, the templates having predetermined characteristics including paper size, margins, data field locations for magnetic ink and non-magnetic ink characters, and locations for magnetic ink characters.

4. The method of claim 2, wherein said identifying step comprises selecting with an input device connected to the computer system the locations within the data fields and elsewhere on the displayed representation of the document where magnetic ink characters are to be printed.

5. The method of claim 2, wherein said comparing step comprises:
selecting one of a plurality of verification templates; and
superimposing the selected verification template on the displayed representation of the document to be printed.

6. The method of claim 5, wherein the verification templates comprise computer readable files.

7. The method of claim 6, wherein the verification templates comprise bit mapped computer files representative of position and dimensioning gauges for magnetic ink character recognition documents.

8. The method of claim 7, wherein said comparing step comprises a computerized process that compares the bit mapped location of the magnetic ink characters on the displayed representation of the document to be printed with the acceptable bit mapped locations of the magnetic ink characters indicated by the verification templates.

9. The method of claim 2, wherein said comparing step further comprises indicating on the displayed representation of the document to be printed any magnetic ink characters that do not conform to the predetermined specifications for the location of such characters.

10. The method of claim 2, comprising the further step of printing at least one copy of the displayed representation of the document.

11. The method of claim 10, comprising the further steps of:
scanning with an optical scanner at least one of the printed documents;
displaying a representation of the scanned document on the display; and
executing said comparing step on the displayed representation of the scanned document.

12. The method of claim 11, wherein said scanning step produces a data file representative of the scanned document.

13. The method of claim 11, comprising the further step of executing said adjusting step based upon the displayed representation of the scanned document to thereby adjust for process variation in the printing process.

14. The method of claim 10, wherein said printing step includes merging data from a computer readable source of data into the data fields of the documents to be printed.

15. A system for creating and printing documents having one or more magnetic ink characters, said system comprising:
a computer having a display, at least one input device, and memory;
application software stored in said memory of said computer and being executable thereby, said application software enabling a user thereof to lay out and display on said display a representation of a document to be printed, identify the locations within the document where magnetic ink characters are to be printed, compare the identified locations where magnetic ink characters are to be printed with predetermined specifications for such locations, and adjust the identified locations on the representation of the document to be printed to conform with the predetermined specifications.

16. The system of claim 15, further comprising at least one printer interconnected with said computer system for printing a document corresponding to the displayed representation of the document to be printed.

17. The system of claim 16, further comprising a scanner electrically interconnected with said computer system, said scanner scanning the printed document and providing a computer readable file representative thereof.

18. The system of claim 17, wherein said application software displays on the display of the computer system a representation of the computer readable file provided by the scanner and executes said comparing step on the displayed representation of the scanned document.

19. The system of claim 15, wherein said application software includes a plurality of document templates, said document templates comprising computer readable files, said document templates having predetermined characteristics including paper size, margins, data field locations for magnetic ink and non-magnetic ink characters, and locations for magnetic ink characters.

20. The system of claim 15, wherein said application software includes a plurality of verification templates, said verification templates comprising bit mapped computer files representative of position and dimensioning gauges for magnetic ink character recognition documents.
